(19) United States
(12) Patent Application Publication
(10) Pub. No.: US 2016/0187679 A1
(43) Pub. Date: Jun. 30, 2016

(54) SWITCHABLE GRATING AND APPLICATION THEREOF

(71) Applicant: NATIONAL SUN YAT-SEN UNIVERSITY, KAOHSIUNG (TW)

(72) Inventors: Tsung-Hsien LIN, KAOHSIUNG (TW); Hung-Chang JAU, KAOHSIUNG (TW); Chun-Ta WANG, KAOHSIUNG (TW); Chien-Tsung HOU, KAOHSIUNG (TW); Cheng-Chang LI, KAOHSIUNG (TW); Chih-Wei WU, KAOHSIUNG (TW)

(21) Appl. No.: 14/745,477

(22) Filed: Jun. 22, 2015

(30) Foreign Application Priority Data
Dec. 25, 2014 (TW) 103145530

(51) Int. Cl. G02F 1/137; G02B 27/22; G02F 1/1347

(52) U.S. Cl. CPC G02F 1/137; G02F 1/13475; G02B 27/2214

(57) ABSTRACT

A switchable grating and an application thereof are provided. The switchable grating includes two electrically conductive substrates and a switchable liquid crystal grating layer, which is disposed between the two electrically conductive substrates. When an electric field is applied to a presumption area of the switchable liquid crystal grating layer by the two electrically conductive substrates, the electric field could shift an orientation of a cholesteric liquid crystal molecule of the presumption area. When the electric field is removed, the cholesteric liquid crystal molecule still maintains the aforementioned orientation, thus decreasing energy consumption. When a display device manufactured by the aforementioned switchable grating switches an image to a 2D image or a 3D image, the display device has lower energy consumption.

### RELATED APPLICATIONS

This application claims priority to Taiwan Application Serial Number 103145530, filed on Dec. 25, 2014, which is herein incorporated by reference.

### BACKGROUND

1. Field of Invention

The present invention relates to a grating, and more particularly to a switchable grating.

2. Description of Related Art

In comparison to a two-dimensional (2D) image of the prior art, a stereoscopic three-dimensional (3D) image can satisfy more requirements of the user in the audiovisual quality. When a user watches the 3D image, the left eye and the right eye of the user respectively receive two different images, generating the binocular parallax, such that the user can experience the stereoscopic 3D image.

In general, the 3D image is appeared by using the patterned retardation layer to shift the polarization direction of the light, and the user has to wear polarized glasses. However, most people feel discomfort after wearing polarized light glasses for a long time, so that it influences the watching emotion.

In order to dissolve the aforementioned defects, a conventional parallax barrier is used to directly separate the image to left and right images that are respectively received by the left eye or the right eye, such that the user can watch the 3D image without wearing the polarized glasses. Moreover, the left and right images can be also mixed by optical films (such as a diffusion plate), so as to display the 2D image.

Please refer to FIG. 1, in which FIG. 1 is a light path diagram of a switchable 2D/3D display device according to a prior art of the present invention when the switchable 2D/3D display device appears a 2D image. The switchable 2D/3D display device 10 includes a parallax barrier 11, a pixel panel 12, an optical film 13 and a light source 14. The light source 14 is used to emit a plurality of lights (not label), and the parallax barrier 11, the pixel panel 12 and the optical film 13 are disposed along the paths of each light. Each light passes through the pixel panel 12, the parallax barrier 11 and the optical film 13 in sequence.

The aforementioned pixel panel 12 includes left image pixels 12a and right image pixels 12b, and the left image pixels 12a and the right image pixels 12b are arranged alternately. The parallax barrier 11 includes first areas 11a (opaque) and second areas 11b (transparent), and the first areas 11a and the second areas 11b are arranged alternately.

Left eye pixel lights 16a refer to the lights emitting from the light source 14 and passing through the left eye pixels 12a, and right eye pixel lights 16b refer to the lights passing through the right eye pixels 12b.

And then, the left eye pixel lights 16a and the right eye pixel lights 16b are mixed by the optical film 13 to emit mixed lights 16c, such that the left eye 15a and the right eye 15b of the user can receive the mixed lights 16c, so as to display the 2D image to the user. In this time, a first electric field is continuously applied to the optical film 13 by the switchable 2D/3D display device 10, and the optical film 13 can mix the left eye pixel lights 16a and the right eye pixel lights 16b.

However, when the first electric field is removed, the left eye pixel lights 16a and the right eye pixel lights 16b cannot be mixed by the optical film 13, such that the switchable 2D/3D display device cannot display 2D image.

Moreover, as the switchable 2D/3D display device 10 is shifted to display a 3D image to the user, a second electric field is continuously applied to the optical film 13 by the switchable 2D/3D display device 10, and the optical film 13 becomes transparent rather than mixing the left eye pixel lights 16a and the right eye pixel lights 16b. In this time, the left eye 15a can merely receive the left eye pixel lights 16a and the right eye 15b can merely receive the right eye pixel lights 16b, so as to display the 3D image to the user.

Similarly, when the second electric field is removed, the switchable 2D/3D display device 10 can not display the 3D image.

Accordingly, when the switchable 2D/3D display device displays the 2D image or the 3D image, the electric field must be continuously applied to the optical film to maintain the optical properties thereof for continuously displaying the 2D image or the 3D image. Thus, the general switchable 2D/3D display device causes energy consumption.

In view of this, there is an urgent need to provide a switchable grating and an application thereof for improving the disadvantages of the conventional switchable grating and the application thereof.

### SUMMARY

Therefore, an aspect of the present invention is to provide a switchable grating. A switchable liquid crystal grating layer of the switchable grating is made by a cholesteric liquid crystal molecule, thereby shifting an orientation of the cholesteric liquid crystal molecule by briefly applying an electric field.

Another aspect of the present invention is to provide a switchable 2D/3D display device. The switchable 2D/3D display device includes the aforementioned switchable grating, so as to switch a display model thereof.

According to the aforementioned aspects of the present invention, the switchable grating is provided. The switchable grating includes two electrically conductive substrates and a switchable liquid crystal grating layer. The two electrically conductive substrates are disposed to each other oppositely and parallelly, and the switchable liquid crystal grating layer is disposed between the two electrically conductive substrates.

The aforementioned switchable liquid crystal grating layer includes a cholesteric liquid crystal molecule and a dichroic black dye, and the switchable liquid crystal grating layer is divided into first areas and second areas.

When a first electric field is applied to the first areas by the two electrically conductive substrates, the cholesteric liquid crystal molecule of the first areas is shifted to a first orientation. When the first electric field is removed, the cholesteric liquid crystal molecule of the first areas is kept in the first orientation, thereby subjecting a light to pass through the first areas and the second areas.

According to the aforementioned aspects of the present invention, a switchable 2D/3D display device is provided. The switchable 2D/3D display device includes a light source, the aforementioned grating layer and a pixel panel. The pixel panel is disposed between the light source and the switchable grating.

The aforementioned light source can emit a plurality of lights, and the switchable grating and the pixel panel are disposed along a path of each light.

The pixel panel includes a plurality of left eye pixels and a plurality of right eye pixels. The left eye pixels and the right eye pixels are arranged alternately.

When the first areas of the switchable grating is kept in the first orientation, the lights that pass through the left eye pixels and the right eye pixels can pass through the first areas and the second areas, so as to appear a first display model to a user.

In the switchable grating and the application thereof of the present invention, the orientation of the cholesteric liquid crystal molecule of the switchable liquid crystal grating layer is transferred by applying the electric field. When the electric field is removed, the cholesteric liquid crystal molecule can be kept in the latest orientation, such that the cholesteric liquid crystal molecule can be kept in the orientation without continuously applying the electric field, so as to decrease the energy consumption.

### BRIEF DESCRIPTION OF THE DRAWINGS

The invention can be more fully understood by reading the following detailed description of the embodiment, with reference made to the accompanying drawings as follows:

FIG. 1 is a light path diagram of a switchable 2D/3D display device according to a prior art of the present invention when the switchable 2D/3D display device appears a 2D image.

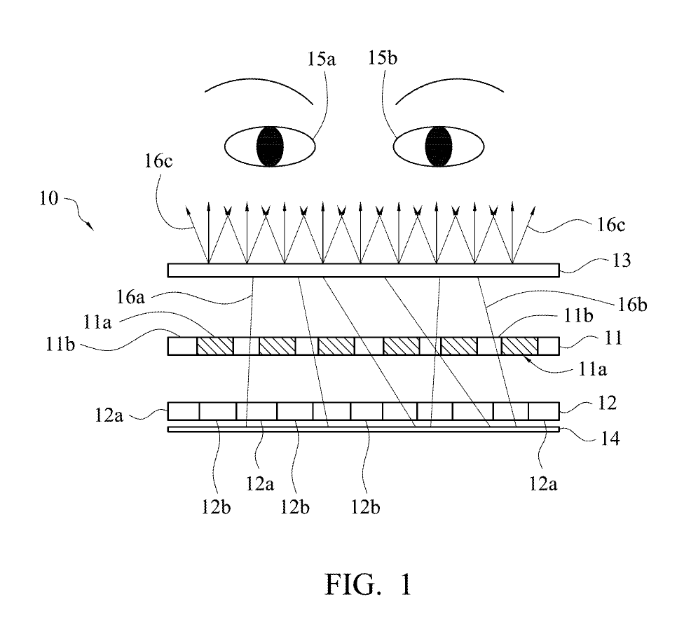

FIG. 2 is a cross-sectional diagram of a switchable grating according to an embodiment of the present invention.

FIG. 3a is a light path diagram according to an embodiment of the present invention when a first electric field is applied to a switchable liquid crystal grating layer by electrically conductive substrates.

FIG. 3b is a light path diagram according to an embodiment of the present invention when a second electric field is applied to a switchable liquid crystal grating layer by electrically conductive substrates.

FIG. 4a is a light path diagram according to an embodiment of the present invention when a switchable 2D/3D display device appears an image.

FIG. 4b is a light path diagram according to an another embodiment of the present invention when a switchable 2D/3D display device appears an image.

### DETAILED DESCRIPTION

In the following description, several specific details are presented to provide a thorough understanding of the fabrication and applications according to embodiments of the present invention. One skilled in the relevant art will recognize, however, that the embodiments of the present invention provide many applicable inventive concepts that can be practiced in various specific contents. The specific embodiments discussed hereinafter are used for explaining but not limited of the scope of the present invention.

A dichroic dye of the present invention has a long-rod molecule structure. When a light passes through the dye, the dye has different light-absorption for every polarization directions. When the polarization direction of the light is parallel to a long-axis of the dye molecule, the dye has a higher light-absorption; when the polarization direction of the light is parallel to a short-axis of the dye molecule, the dye has a lower light-absorption.

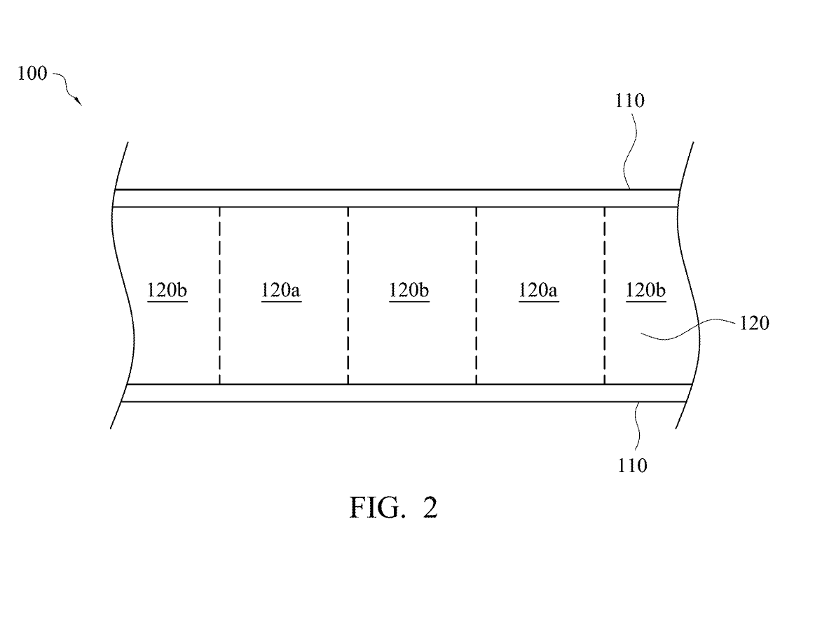

Please refer to FIG. 2, FIG. 2 is a cross-sectional diagram of a switchable grating according to an embodiment of the present invention. In one embodiment, a switchable grating 100 includes two electrically conductive substrates 110 and a switchable liquid crystal grating layer 120. The two electrically conductive substrates 100 are disposed to each other oppositely and parallelly, and the switchable liquid crystal grating layer 120 is disposed between two electrically conductive substrates 110.

In an embodiment, the electrically conductive substrate can be a transparent electrically conductive film (such as indium-tin oxide film), and a substrate of the electrically conductive film can be a glass substrate or a polymeric substrate.

The aforementioned switchable liquid crystal grating layer 120 includes a cholesteric liquid crystal molecule and a dichroic black dye. The switchable liquid crystal grating layer 120 is divided into first areas 120a and second areas 120b, and the first areas 120a and the second areas 120b are arranged alternately.

For example, the dichroic black dye can include but be not limited to a commercial product fabricated by Mitsui Chemical Inc. (the trade name is S428), other suitable dichroic black dyes or a combination thereof.

When the switchable liquid crystal grating layer 120 includes the dichroic black dye, the dichroic black dye can subject the switchable liquid crystal grating layer 120 to absorb the light, thereby decreasing a transmittance of an area, further achieving a displaying efficacy of the 3D image of the switchable liquid crystal grating layer 120.

In an embodiment, the switchable liquid crystal grating layer 120 further includes at least a polymer material.

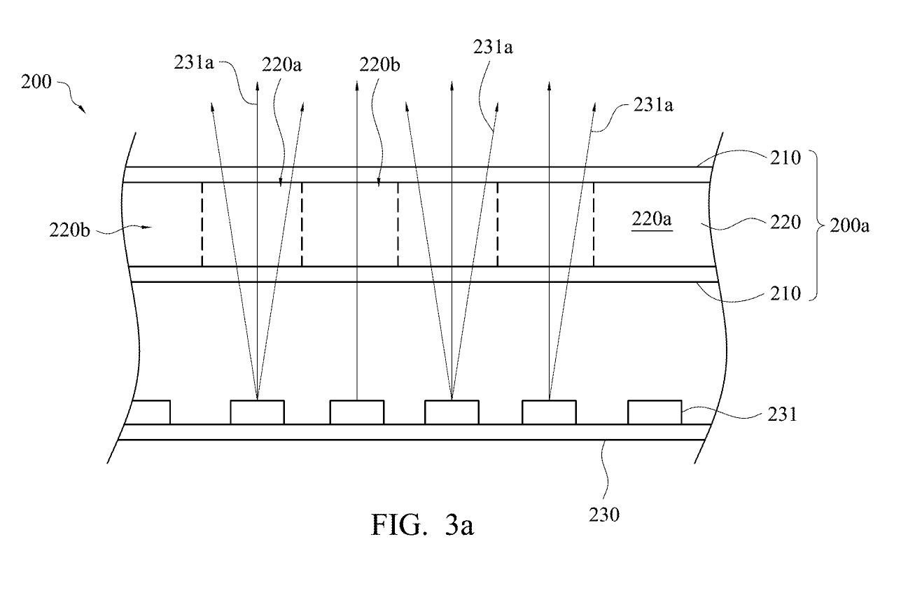

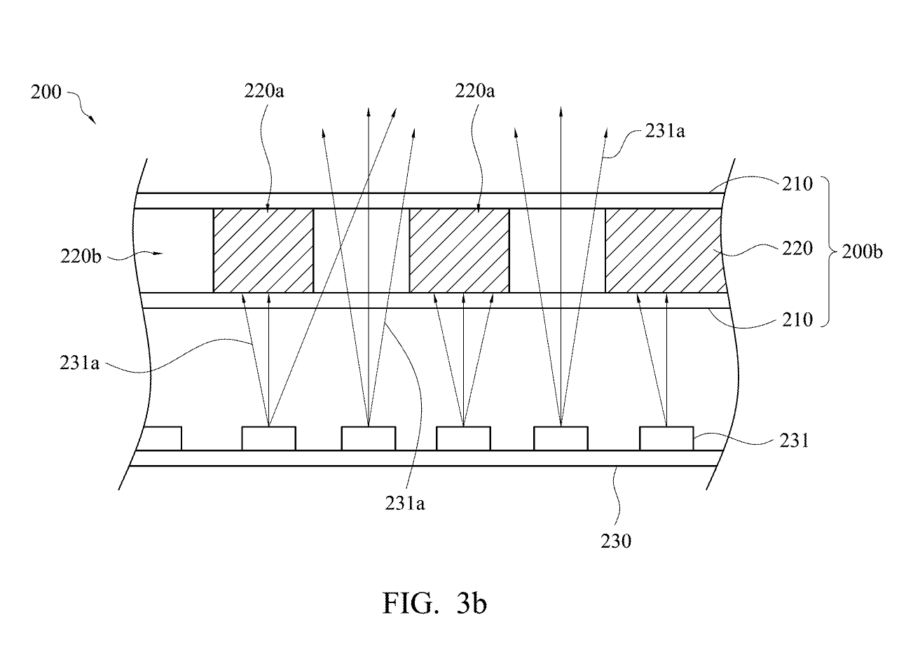

Please refer to FIG. 3a and FIG. 3b, FIG. 3a and FIG. 3b respectively are light path diagrams according to an embodiment of the present invention when a first electric field or a second electric field are applied to a switchable liquid crystal grating layer by electrically conductive substrates. The switchable grating 200a and 200b are substantially similar to the switchable grating 100, but the difference therebetween resides that the electrically conductive substrates whether an electric field is applied to the switchable grating or not. Besides, the switchable grating 200b in FIG. 3b represents that the electrically conductive substrates 210 have applied a second electric field to the switchable grating 200a.

In FIGS. 3a and 3b, a device 200 includes the switchable grating 200a or 200b and a light source 230. The light source 230 includes at least one light emitting diodes 231. In an embodiment, the light source 230 can be a cold cathode fluorescent lamp, other suitable emitting light sources or a combination thereof.

In FIG. 3a, when the first electric field is applied to the first areas 220a and the second areas 220b of the switchable liquid crystal grating layer 220 by the electrically conductive substrates 210, the cholesteric liquid crystal molecules in the first areas 220a and the second areas 220b are shifted to a first orientation. When the first electric field is removed, according to an effect of a stable state of the cholesteric liquid crystal molecule, the cholesteric liquid crystal molecules in the first areas 220a and the second areas 220b can be kept in the first orientation without applying any electric field additionally.

The aforementioned first electric field can be a low frequency longitudinal electric field (the frequency is 30 Hz to 100 Hz) to make the cholesteric liquid crystal molecule shift to uniform lying helix state (abbreviated as ULH state; i.e. the aforementioned first orientation). A screw axis of the cholesteric liquid crystal molecule with ULH state is parallel to the electrically conductive substrates 210, thereby subjecting a light 231a emitting from the emitting diodes 231 to pass through the first areas 220a and the second areas 220b, thus emitting from the switchable liquid crystal grating layer 220.

In FIG. 3b, when the second electric field is applied to the first areas 220a of the switchable liquid crystal grating layer 220 by the electrically conductive substrates 210, the cholesteric liquid crystal molecule of the first areas 220a can shift to a second orientation. When the second electric field is removed, according to an effect of the stable state of the cholesteric liquid crystal molecule, the cholesteric liquid crystal molecule of the first areas 220a can be kept in the second orientation without applying any electric field additionally.

The aforementioned second electric field can be a high frequency longitudinal electric field (the frequency is at least 1 KHz). The high frequency longitudinal electric field is removed in a moment to subject the cholesteric liquid crystal molecule to shift to planar texture state (abbreviated as P state; i.e. the aforementioned second orientation). A screw axis of the cholesteric liquid crystal molecule with P state is perpendicular to the electrically conductive substrates 210, thereby allowing the light 231a emitting from the emitting diodes 231 to pass through the second areas 220b but to be blocked by the first areas 220a.

In FIG. 3b, if the low frequency longitudinal electric field is continuously applied to the cholesteric liquid crystal molecule with P state in the first areas 220a, the cholesteric liquid crystal molecule of the first areas 220a can shift to ULH state, thereby subjecting the light 231a emitting from the emitting diodes 231 to pass through the first areas 220a and the second areas 220b.

Therefore, when an electric field is applied to the switchable liquid crystal grating layer 220 by the electrically conductive substrates 210, based on the influence of the electric field, the cholesteric liquid crystal molecule in the switchable liquid crystal grating layer 220 can switch the orientation. According to the effect of the stable state of the cholesteric liquid crystal molecule, after the electric field is removed, the cholesteric liquid crystal molecule does not shift the orientation, so as to be kept in the latest orientation as the one that the electric field does not be removed.

Please refer to FIG. 3a, in one embodiment, when the aforementioned switchable liquid crystal grating layer 220 includes at least a polymer material and the first electric field is applied to the first areas 220a and the second areas 220b of the switchable liquid crystal grating layer 220 by the electrically conductive substrates 210, the first electric field can make the cholesteric liquid crystal molecule shift to the first orientation, and the polymer material and the cholesteric liquid crystal molecule appears a phase separation, thereby subjecting the cholesteric liquid crystal molecule to be more stable. When the first electric field is removed, the phase separation caused by the polymer material will keep the cholesteric liquid crystal molecule in the first orientation without applying any electric field additionally.

The aforementioned first electric field can be high frequency longitudinal electric field (the frequency is at least 1 KHz) to subject the cholesteric liquid crystal molecule to shift to homeotropic state (abbreviated as H state; i.e. the aforementioned second orientation). An arrangement of the cholesteric liquid crystal molecule with H state is perpendicular to the electrically conductive substrates 210, thereby subjecting the light 231a emitting from the emitting diodes 231 to pass through the first areas 220a and the second areas 220b. According to the stable effect of the phase separation caused by the polymer material, after the electric field is removed, the cholesteric liquid crystal molecule can be kept in H state.

In FIG. 3b, in one embodiment, when the aforementioned switchable liquid crystal grating layer 220 includes at least a polymer material and the second electric field is applied to the first areas 220a of the switchable liquid crystal grating layer 220 by the electrically conductive substrates 210, the second electric field can orient the cholesteric liquid crystal molecule to the second orientation. When the second electric field is removed, according to the effect of the stable state of the cholesteric liquid crystal molecule, the cholesteric liquid crystal molecule of the first areas 220a can be kept in the second orientation without applying any electric field additionally.

The aforementioned second electric field can be a transverse electric field to subject the cholesteric liquid crystal molecule to shift to focal conic texture state (abbreviated as F state; i.e. the aforementioned second orientation). An arrangement of a screw axis of the cholesteric liquid crystal molecule with F state is disorderly, thereby allowing the light 231a emitting from the emitting diodes 231 to pass through the second areas 220b but to be blocked by the first areas 220a.

Similarly, if the aforementioned high frequency longitudinal electric field is continuously applied to the cholesteric liquid crystal molecule with F state in the first areas 220a, the cholesteric liquid crystal molecule of the first areas 220a can be shifted to H state, thereby subjecting the light 231a emitting from the emitting diodes 231 to pass through the first areas 220a and the second areas 220b.

In the same way, when the electric field is applied to the switchable liquid crystal grating layer 220 by the electrically conductive substrates 210, based on the influence of the electric field, the cholesteric liquid crystal molecule of the switchable liquid crystal grating layer 220 will transfer the orientation. Because the intrinsic stable state of the cholesteric liquid crystal molecule and the structure of the polymer material can further steady the orientation of the cholesteric liquid crystal molecule, after the electric field is removed, the cholesteric liquid crystal molecule can be kept in the orientation, thereby maintaining the orientation as the same as the one that the electric field does not be removed.

In one embodiment, the aforementioned polymer material can be polymerized by a mixture comprising a polymer monomer and a polymerized initiator. The polymer monomer is a polymerizable polymer monomer, and the polymerized initiator can include photo-polymerized initiator, heat-polymerized initiator, other suitable polymerized initiators and a combination thereof.

For example, the aforementioned polymer material can include but be not limited to 1,4-bis-[4-(3-acryloyloxypropyloxy)benzoyloxy]-2-methylbenzene (abbreviated as RM257), other polymerizable polymer monomer or a combination thereof.

The aforementioned polymerized initiator can include but be not limited to 2,2-dimethoxy-1,2-diphenylethanone (abbreviated as IRG651), azobisisobutyronitrile (abbreviated as AIBM), other suitable polymerized initiators or a combination thereof.

When the switchable liquid crystal grating layer including the polymer material is fabricated, the cholesteric liquid crystal molecule is firstly mixed with the nonpolymerized polymer monomer to form a liquid crystal mixture, and the liquid crystal mixture is utilized to fabricate the switchable liquid crystal grating layer of the switchable grating. The liquid crystal mixture can include the polymerized initiator.

Then, the first electric field is applied to the switchable liquid crystal grating layer to orient the cholesteric liquid crystal molecule to the first orientation by the electrically conductive substrates. In a situation that the first electric field is not removed, according to the difference of the polymerized initiator, a method, such as lighting, heating or other methods that can induce the polymerized reaction, is performed to the switchable liquid crystal grating layer to polymerize the polymer material that can cause the phase separation, so as to affect the arrangement of the liquid crystal molecule.

After the polymerized reaction is completed, the first electric field, a light source of lighting, a heat source of heating or an apparatus that can produce effects of the aforementioned other methods are removed. Because the polymer material can steady the orientation of the cholesteric liquid crystal molecule, when the first electric field and the aforementioned apparatus are removed, a molecule chain of the polymer material can keep the cholesteric liquid crystal molecule of the first orientation without applying any electric field additionally.

In yet another embodiment, a reacting temperature of the aforementioned polymerized reaction is lower than a phase transition temperature of the cholesteric liquid crystal molecule.

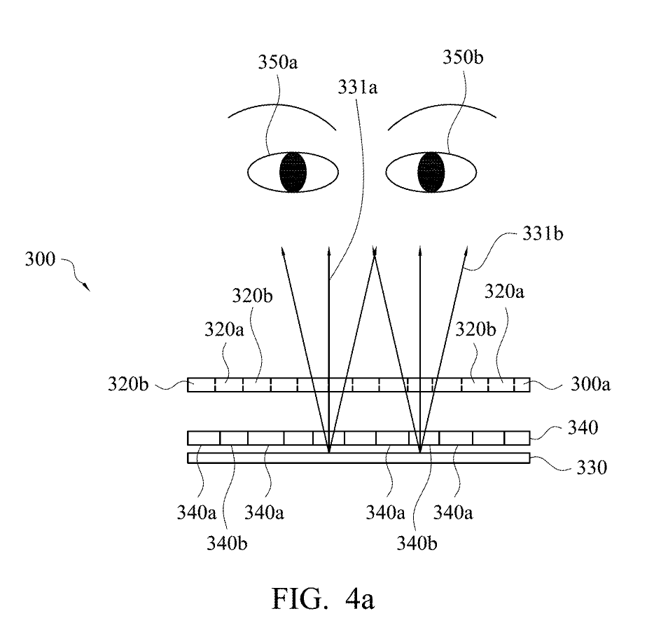

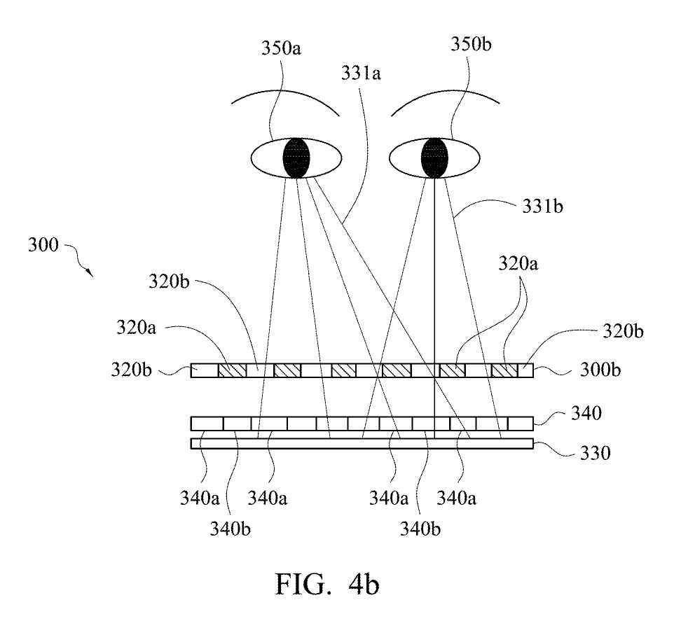

Please refer to FIG. 4a, FIG. 4a is a light path diagram according to an embodiment of the present invention when a switchable 2D/3D display device appears an image. The switchable grating 300a is substantially similar to the switchable grating 100, but the difference therebetween resides that the electrically conductive substrates whether an electric field is applied to the switchable grating or not.

In one embodiment, the switchable 2D/3D display device includes a light source 330, a swichable grating 300a and a pixel panel 340. The light source 330 is used to emit a plurality of lights (not label), the switchable grating 300a and the pixel panel 340 are disposed along light paths of each light, and the pixel panel 340 is disposed between the light source 330 and the switchable grating 300a.

The pixel panel 340 includes a plurality of left eye pixels 340a and a plurality of right eye pixels 340b, and the plurality of left eye pixels 340a and the plurality of right eye pixels 340b are arranged alternately.

When the aforementioned lights pass through the left eye pixels, the lights will turn into left eye image lights 331a. When the aforementioned lights pass through the right eye pixels, the lights will turn into right eye image lights 331b.

When the first electric field is applied to the first areas 320a and the second areas 320b of the switchable liquid crystal grating layer (not label) by the electrically conductive substrates (not label), the cholesteric liquid crystal molecule of the first areas 320a and the second areas 320b will shift to the first orientation. When the first electric field is removed, the cholesteric liquid crystal molecule can be kept in the first orientation without applying any electric field additionally.

The aforementioned first electric field can be a low frequency longitudinal electric field (the frequency is 30 Hz to 100 Hz) to subject the cholesteric liquid crystal molecule to shift to ULH state, thereby subjecting the left eye image lights 331a and the right eye image lights 331b can both pass through the first areas 320a and the second areas 320b, such that the left eye 350a and the right eye 350b can both simultaneously receive the left eye image lights 331a and the right eye image lights 331b, so as to appear a first display model to the user. The first display model can be a 2D image.

When the switchable 2D/3D display device of the present invention is used to display the 2D image or the 3D image, the switchable 2D/3D display device does not include a diffusion plate or other optical films that can mix the lights for achieving the switching between the 2D image and the 3D image.

Please refer FIG. 4b, FIG. 4b is a light path diagram according to an another embodiment of the present invention when a switchable 2D/3D display device appears an image. The switchable grating 300b is substantially similar to the switchable grating 100, but the difference therebetween resides that the electrically conductive substrates whether an electric field is applied to the switchable grating or not. Besides, the switchable grating 300b in FIG. 4b represents that the electrically conductive substrates have applied the second electric field to the switchable grating 300a, thereby subjecting the switchable grating to achieve different light-transparent effects.

In FIG. 4b. When the second electric field is applied to the first areas 320a of the switchable liquid crystal grating layer (not label) by the electrically conductive substrates (not label), the cholesteric liquid crystal molecule of the first areas 320a will shift to the second orientation. When the second electric field is removed, the cholesteric liquid crystal molecule of the first areas 320a will not transfer the orientation.

The aforementioned second electric field can be a high frequency longitudinal electric field (the frequency is at least 1 KHz). The high frequency longitudinal electric field is removed in a moment to subject the cholesteric liquid crystal molecule of the first areas 320a to shift to P state, such that the left eye image lights 331a and the right eye image lights 331b can pass through the second areas 320b but be blocked by the first areas 320a, such that the switchable grating 300b can make the left eye 350a receive the left eye image lights 331a and the right eye 350b receive the right eye image lights 331b, so as to appear a second display model to the user. The second display model can be a 3D image.

In FIG. 4b, if the low frequency longitudinal electric field is continuously applied to the cholesteric liquid crystal molecule with P state in the first areas 320a, the cholesteric liquid crystal molecule of the first areas 320a can shift to ULH state, such that the light emitting from the light source 330 can pass through the first areas 320a and the second areas 320b.

Similarly, when the switchable liquid crystal grating layer includes the polymer material, and different electric fields are applied to the switchable liquid crystal grating layer by the electrically conductive substrates, the cholesteric liquid crystal molecule can shift to different stable orientations, and the electric field does not need to be applied continuously, thereby achieving the light-filtrating effect of the grating, so as to appear the first display model or the second display model.

According to the aforementioned embodiments, the switchable liquid crystal grating layer of the switchable grating of the present invention is fabricated by the bistable orientation of the cholesteric liquid crystal molecule, so as to orient the cholesteric liquid crystal molecule to stable orientations by applying the electric field. Moreover, when the electric field is removed, the cholesteric liquid crystal molecule can be kept in the orientation. Therefore, the electric field does not need to be applied continuously for keeping an original display model. The electric field is applied to the switchable grating by the electrically conductive substrates when the user wants switch the display model, so as to achieve the effect of energy-saving.

Moreover, when the switchable liquid crystal grating layer includes the polymer material, the polymer material can further stabilize and keep the cholesteric liquid crystal molecule in different orientations. After the orientation of the cholesteric liquid crystal molecule is shifted, the electric field is unnecessarily applied to the switchable liquid crystal grating layer continuously for keeping it in a desired orientation, so as to decreasing the energy consumption.

Furthermore, the switchable grating of the present invention can achieve the random switching between 2D image and 3D image, and the user does not need to wear a polarized glasses or other accessories for watching the 2D image or the 3D image.

Besides, the dichroic dye can subject the switchable liquid crystal grating layer to absorb the light, thereby decreasing a transmittance of an area, further achieving a displaying efficacy of the 3D image of the switchable liquid crystal grating layer.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A switchable grating, comprising:
two electrically conductive substrates, wherein the two electrically conductive substrates are disposed to each other oppositely and parallelly; and
a switchable liquid crystal grating layer, disposed between the two electrically conductive substrates, wherein the switchable liquid crystal grating layer includes a cholesteric liquid crystal molecule and a dichroic black dye, and the switchable liquid crystal grating layer is divided into first areas and second areas, and
wherein when a first electric field is applied to the first areas by the two electrically conductive substrates, the cholesteric liquid crystal molecule of the first areas is shifted to a first orientation; or when the first electric field is removed, the cholesteric liquid crystal molecule of the first areas is kept in the first orientation, thereby allowing a light to pass through the first areas and the second areas.

2. The switchable grating of claim 1, wherein when a second electric field is applied to the first areas by the two electrically conductive substrates, the cholesteric liquid crystal molecule of the first areas is shifted to a second orientation; or when the second electric field is removed, the cholesteric liquid crystal molecule of the first areas is kept in the second orientation, thereby allowing the light to pass through the second areas but to be blocked by the first areas.

3. The switchable grating of claim 1, wherein the cholesteric liquid crystal molecule further includes at least a polymer material, and the polymer material is polymerized by a mixture comprising a polymer monomer and a polymerized initiator.

4. The switchable grating of claim 3, wherein when the first electric field is applied or removed, the polymer material keeps the cholesteric liquid crystal molecule of the first areas to be kept in the first orientation.

5. The switchable grating of claim 3, wherein when a second electric field is applied to the first areas by the two electrically conductive substrates, the cholesteric liquid crystal molecule of the first areas is shifted to a second orientation; or when the second electric field is removed, the cholesteric liquid crystal molecule of the first areas is kept in the second orientation, thereby allowing the light to pass through the second areas but to be blocked by the first areas.

6. A switchable two-dimensional/three-dimensional (2D/3D) display device, comprising:
a light source, used to emit a plurality of lights;
a switchable grating, wherein the switchable grating comprises:
two electrically conductive substrates, wherein the two electrically conductive substrates are disposed to each other oppositely and parallelly; and
a switchable liquid crystal grating layer, disposed between the two electrically conductive substrates, wherein the switchable liquid crystal grating layer includes a cholesteric liquid crystal molecule and a dichroic black dye, and the switchable liquid crystal grating layer is divided into first areas and second areas, and
wherein when the cholesteric liquid crystal molecule of the first areas is kept in a first orientation, the lights pass through the first areas and the second areas; and
a pixel panel, disposed between the light source and the switchable grating, and the pixel panel includes a plurality of left eye pixels and a plurality of right eye pixels, wherein the left eye pixels and the right eye pixels are arranged alternately, and
wherein the switchable grating and the pixel panel are disposed along a path of each light; when the cholesteric liquid crystal molecule of the first areas is kept in the first orientation, the lights through the left eye pixels and the right eye pixels pass through the first areas and the second areas, thereby appearing a first display model to a user.

7. The switchable 2D/3D display device of clam 6, wherein when a first electric field is applied to the first areas by the two electrically conductive substrates, the cholesteric liquid crystal molecule of the first areas is shifted to the first orientation; or when the first electric field is removed, the cholesteric liquid crystal molecule of the first areas is kept in the first orientation.

8. The switchable 2D/3D display device of clam 7, wherein the first display model is a 2D image.

9. The switchable 2D/3D display device of clam 6, wherein when the first areas of the switchable grating is kept in a second orientation, the lights through the left eye pixels and the second areas are received by left eye of the user, and the lights through the right eye pixels and the second areas are received by right eye of the user, thereby appearing a second display model to the user.

10. The switchable 2D/3D display device of clam 9, wherein when a second electric field is applied to the first areas by the two electrically conductive substrates, the cholesteric liquid crystal molecule of the first areas is shifted to the second orientation; or when the second electric field is removed, the cholesteric liquid crystal molecule of the first areas is kept in the second orientation.

11. The switchable 2D/3D display device of clam 10, wherein the second display model is a 3D image.

12. The switchable 2D/3D display device of claim 6, wherein the cholesteric liquid crystal molecule further includes at least a polymer material, and the polymer material is polymerized by a mixture comprising a polymer monomer and a polymerized initiator.

13. The switchable 2D/3D display device of clam 12, wherein when a first electric field is applied to the first areas by the two electrically conductive substrates, the cholesteric liquid crystal molecule of the first areas is shifted to the first orientation; or when the first electric field is removed, the cholesteric liquid crystal molecule of the first areas is kept in the first orientation, thereby allowing the lights to pass through the first areas and the second areas.

14. The switchable 2D/3D display device of clam 12, wherein when the first areas of the switchable grating is kept in a second orientation, the lights through the left eye pixels and the second areas are received by left eye of the user, and the lights through the right eye pixels and the second areas are received by right eye of the user, thereby appearing a second display model to the user.

15. The switchable 2D/3D display device of clam 14, wherein when a second electric field is applied to the first areas by the two electrically conductive substrates, the cholesteric liquid crystal molecule of the first areas is shifted to a second orientation; or when the second electric field is removed, the cholesteric liquid crystal molecule of the first areas is kept in the second orientation, thereby allowing the lights to pass through the second areas but to be blocked by the first areas.
